(19) United States
(12) Patent Application Publication
(10) Pub. No.: US 2015/0147131 A1
(43) Pub. Date: May 28, 2015

(54) LOAD BINDING DEVICE

(71) Applicant: Beau William MCARTHUR, Sundre (CA)

(72) Inventor: Beau William MCARTHUR, Sundre (CA)

(21) Appl. No.: 14/090,395

(22) Filed: Nov. 26, 2013

(51) Int. Cl. B60P 7/08

(52) U.S. Cl. CPC B60P 7/0823
USPC 410/100

(57) ABSTRACT

Provided herein is a load binding device for securing and/or tightening the load on a flatbed trailer or deck; wherein the device comprises a winch in operable association with a manual slack adjuster. Also provided herein is a system or kit comprising the load binding device disclosed herein.

### FIELD OF THE INVENTION

The present invention relates to the field of load binding devices such as winches and systems relating thereto, particularly for cinching, tightening, securing and/or maintaining loads atop a deck or open flatbed-type surface such as on a vehicle or the like.

### BACKGROUND OF THE DISCLOSURE

It is a common and often well regulated practice to secure a cargo load to a deck or flatbed surface of a vehicle through the use of tie downs, such as bindings or straps, which surround the outer boundaries of the load and connect to anchor points along opposite sides of the deck or flatbed. Such cargo load configurations vary considerably and therefore require a convenient means for adjustment and tie down.

It is current practice to tie down and secure cargo loads with straps through a winch and winch bar system. This system requires threading the end of each strap through slits in the winches; and pulling the excess strap all the way through the slits. Such a system also requires the user to insert the tip of a winch bar, such as a 3-foot long pipe adaptor, through a winch hole to set/release the pin and/or to crank the winch bar using the full force of the user's hands and body weight. In order to properly tighten and/or secure a load with such a system, the user must exert their maximum strength; thereby creating unfortunate risks for slipping and/or for causing injury to the user's body.

Load binding winch systems for securing cargo loads on flatbed trailers are readily available and may be found, for example, in U.S. Pat. Nos. 3,077,791; 3,101,927; 3,240,478; 4,823,443; 4,913,608; 5,791,844; 7,108,246; 7,192,009; 7,216,849; and 8,308,410; U.S. Publication No. 20120205601; CA Publication No. 1319674C; and WO Publication No. 2000056573; however, none of these references and/or corresponding counterparts disclose the embodiments of the present invention.

Therefore, a need exists in the art for a load binding device and system for proper tightening and/or securing of cargo loads to decks or flatbed trailers with extreme ease of use, particularly for individual users having limited muscle power and/or body strength.

All documents and references cited herein and in the referenced patent documents, are hereby incorporated herein by reference.

### SUMMARY OF THE INVENTION

The present inventors have designed, constructed, and developed an innovative device for tightening and/or securing cargo loads to flatbed trailers or decks. Such a load binding device is capable of ensuring proper tightening of straps for securing a cargo load to a deck or flatbed-type surface with the ease of use of standard tools and without the need for the user to exert full force and/or maximum strength, such as in the use of a winch bar.

Disclosed herein is a load binding device for tightening and securing loads on a deck or flatbed surface; the device comprises a winch in operable association with a slack adjuster; wherein the slack adjuster comprises a locking mechanism. In another embodiment, the locking mechanism is a semi-automatic locking mechanism. In another embodiment, the locking mechanism comprises a bolt head. In another embodiment, the bolt head operably corresponds to a hand tool. In another embodiment, the hand tool is a wrench or hand ratchet. In a further embodiment, the wrench is an electric or pneumatic impact wrench. In an additional further embodiment, the hand ratchet is a speed handle. In another embodiment, the locking mechanism comprises a 9/16″ bolt head.

Additionally, disclosed herein is a system for tightening and/or securing loads on a deck or flatbed surface; the system comprises (a) a device comprising a winch in operable association with a slack adjuster; wherein the slack adjuster comprises a locking mechanism; (b) tie downs for a tightening a load on the deck or flatbed surface; and (c) a hand tool for setting and/or releasing the locking mechanism of the device. In another embodiment, the locking mechanism is a semi-automatic locking mechanism. In another embodiment, the locking mechanism comprises a bolt head. In another embodiment, the bolt head operably corresponds to a hand tool. In another embodiment, the hand tool is a wrench or hand ratchet. In a further embodiment, the wrench is an electric or pneumatic impact wrench. In an additional further embodiment, the hand ratchet is a speed handle. In another embodiment, the locking mechanism comprises a 9/16″ bolt head.

Also disclosed herein is a kit for tightening and/or securing loads on a deck or flatbed surface; the kit comprises (a) a device comprising a winch in operable association with a slack adjuster; wherein the slack adjuster comprises a locking mechanism; (b) tie downs for a tightening a load on the deck or flatbed surface; and (c) a hand tool for setting and/or releasing the locking mechanism of the device. In another embodiment, the locking mechanism is a semi-automatic locking mechanism. In another embodiment, the locking mechanism comprises a bolt head. In another embodiment, the bolt head operably corresponds to a hand tool. In another embodiment, the hand tool is a wrench or hand ratchet. In a further embodiment, the wrench is an electric or pneumatic impact wrench. In an additional further embodiment, the hand ratchet is a speed handle. In another embodiment, the locking mechanism comprises a 9/16″ bolt head.

In another embodiment, the load binding device is capable of being mounted to the deck or flatbed surface.

In other embodiments, the load binding device in the preceding paragraphs may additionally incorporate any of the preceding or subsequent disclosed embodiments.

The Summary of the Invention is not intended to define the claims nor is it intended to limit the scope of the invention in any manner.

Other features and advantages of the invention will be apparent from the following Drawings, Detailed Description, and the Claims.

### BRIEF DESCRIPTION OF THE DRAWINGS

FIG. 1 illustrates a perspective view of an embodiment of a load binding device comprising a winch in operable association with a slack adjuster.

FIG. 2 illustrates a perspective view of an embodiment of the frame of a winch capable of being operably associated with a slack adjuster.

FIG. 3 illustrates an alternative side perspective view of an embodiment of the frame of a winch capable of being operably associated with a slack adjuster.

### DETAILED DESCRIPTION OF THE EMBODIMENTS

The present invention is illustrated in the drawings and description in which like elements are assigned the same reference numerals. However, while particular embodiments are illustrated in the drawings, there is no intention to limit the present invention to the specific embodiment or embodiments disclosed. Rather, the present invention is intended to cover all modifications, alternative constructions, and equivalents falling within the spirit and scope of the invention. As such, the drawings are intended to be illustrative and not restrictive.

Unless otherwise defined, all technical terms used herein have the same meaning as commonly understood by one of ordinary skill in the art to which this technology belongs.

For the purposes of the present invention, a load binding “winch” is well known and readily available in the art. The terms “winch”, “device”, “system”, “winch device”, “winch system” may be used interchangeably herein. Generally, a winch is a mechanical device that is used to pull in, or wind up, or let out, or wind out, or otherwise adjust the tension or slack of a corresponding rope, cable, wire, or strap. The winch typically comprises a spool and/or winch drum, and a crank and/or ratchet. Winches may be designed to include gears, pawls, and/or gear assemblies and/or ratchet and pawl components which preclude the unwinding action of a rope, cable, wire, or strap.

For the purposes of the present invention, a “slack adjuster” is well known and readily in the art. A slack adjuster may function in a manual, automatic, and/or semi-automatic manner and generally functions with respect to adjustable inner and outer interlocking gears. Slack adjusters may be found, for example, in U.S. Pat. Nos. 2,156,154; 3,361,230; 3,933,056; and are typically used for brake linkage in automobiles where it is desired to provide for adjustment of slack up to a particular load weight. The adjustment mechanism functions to remove true slack but not stretch.

For the purposes of the present invention, the terminology “operably associated with” or “in operable association with” means mechanically mounted and/or affixed using mechanical means known and readily available in the art; such as, without limitation, nuts and bolts, screws, washers, shims, shafts, round bars, ratchets and ratchet wheels, and clips. In some embodiments, spacer blocks are inserted at the bottom/tail end of the slack adjuster which is operably associated with the arm of the winch.

For the purposes of the present invention, the terminology “operably corresponds to” means that there is a functional relationship between the two objects which operably correspond to each other. For example, a locking mechanism of the device disclosed herein operably corresponds to or functions with a corresponding hand tool.

For the purposes of the present invention, the terms “straps” and “tie downs” and “tie straps” shall be understood to mean any and all types of tie down capability for securing cargo loads to a deck or flatbed surface, such as, without limitation, bindings, straps, cables, wires, belts, and ropes.

For the purposes of the present invention, the terms “deck” or “flatbed surface” may be found for, example, on flatbed trailers and/or trucks, and/or may be found on other types of transportation vehicles, objects, and/or places often associated with cargo loads, such as freight trains or railcars, airplanes, container ships, boats, construction sites, and/or warehouses. The terms may also be found in other fields as apparent to a person skilled in the art. For this reason, expressions such as “deck”, “flatbed”, “truck”, “load”, “cargo load” etc., used herein should not be taken as to limit the scope of the present invention and includes all other types of objects or related fields with which the present invention may be used and may be useful.

For purposes of the present invention, hand tools corresponding to the load binding device disclosed herein are known and readily available. Such hand tools may include, without limitation, a wrench such as an electric or pneumatic impact wrench, and a ratchet such as a hand ratchet or a speed handle. Slack check tools may be found, for example, in U.S. Pat. No. 5,613,412.

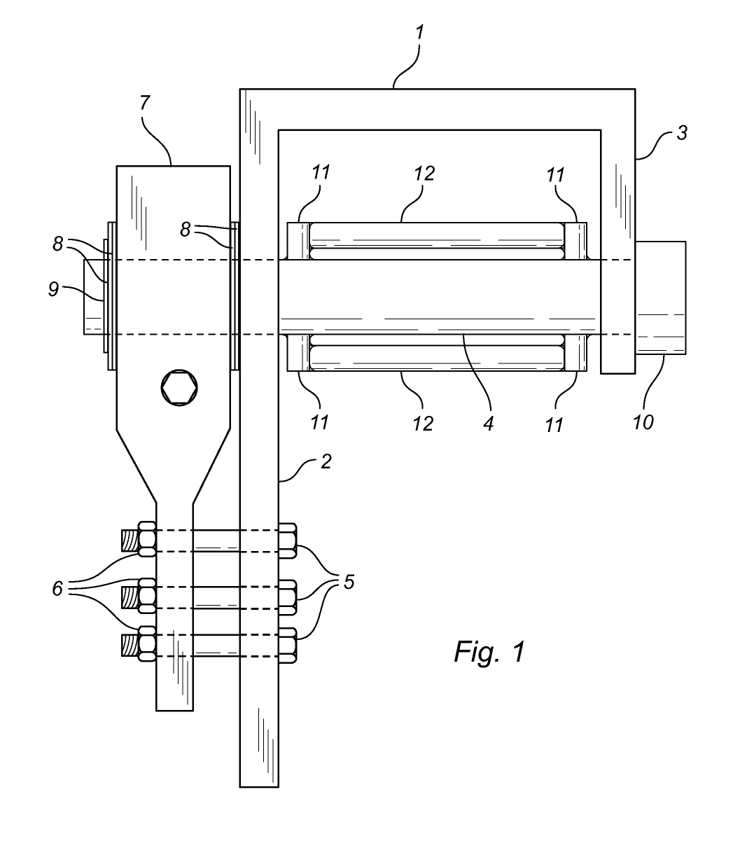

Exemplary embodiments of the present invention are depicted in FIGS. 1-3.

FIG. 1 illustrates a perspective view of an embodiment of a load binding device disclosed herein. In particular, 1, 2, 3 flat bars form a 3-sided frame of the winch. A 4 shaft operably associates the winch and the 7 slack adjuster. In some embodiments, the shaft comprises a center slot for the straps. 5 Bolts and 6 lock nuts operably associate the 2 flat bar arm of the winch frame which is adjacent to the 7 slack adjuster with the tail/bottom end of the 7 slack adjuster. 8 Shims may be located on either side of the 7 slack adjuster and a 9 snap ring may be located atop the 8 shims on the side of the 7 slack adjuster opposite the 2 flat bar of the winch frame. In some embodiments, open spaces between the flat bar arm of the winch frame and the tail/bottom end of the slack adjuster may be filled with space blocks (not shown). An 10 HSS (hollow structural section) steel piece is located on the opposite 3 flat bar of the winch frame. 11 Steel tipped 12 round bars are on either side of the 4 shaft within the winch frame.

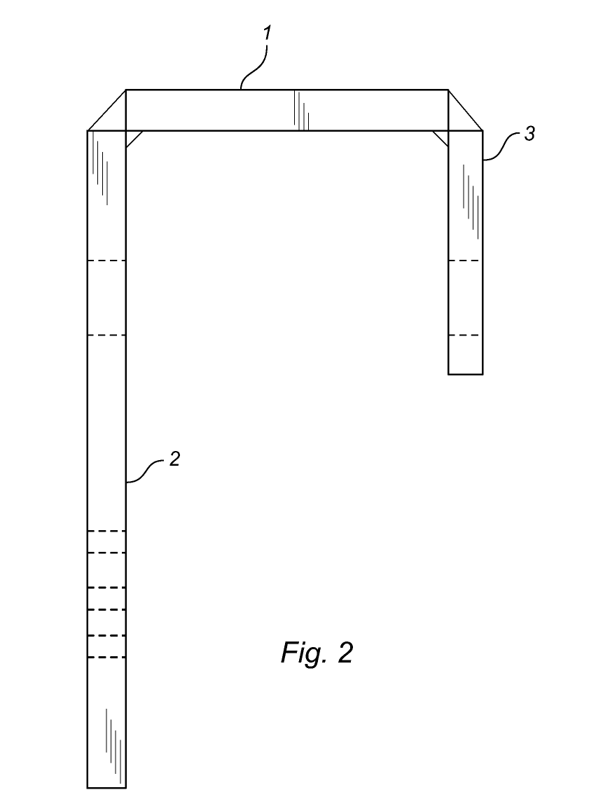

FIG. 2 illustrates a perspective view of an embodiment of the 1, 2, 3 flat bars of the winch frame capable of being operably associated with a 7 slack adjuster. In some embodiments, the frame includes welded joints. Exemplary specifications for operable association of the winch frame and the 7 slack adjuster are shown, without limitation.

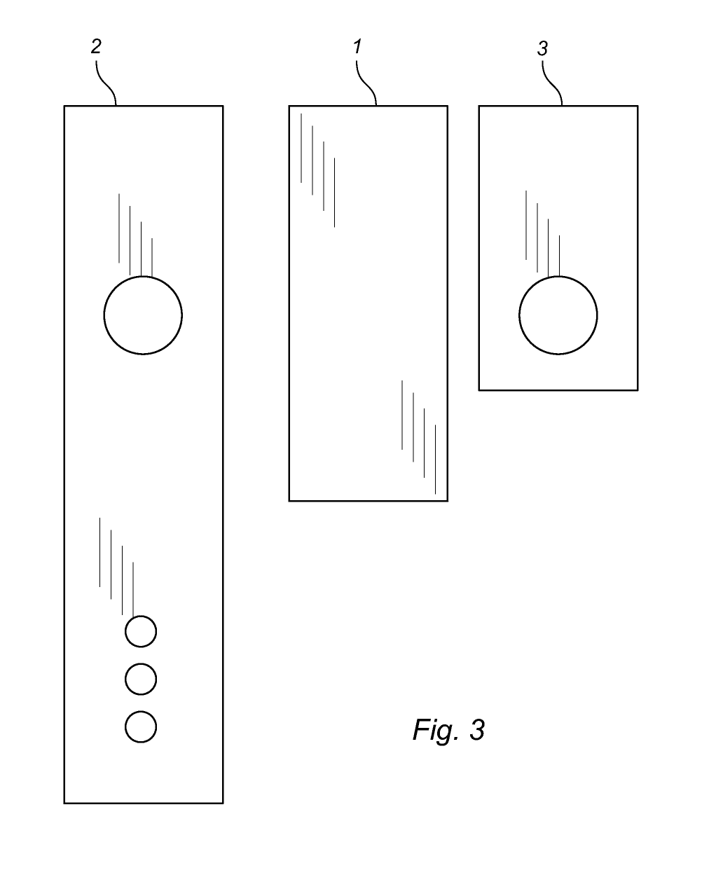

FIG. 3 shows a side perspective view of an embodiment of the 1, 2, 3 flat bars of winch frame capable of being operably associated with a 7 slack adjuster. Exemplary specifications for operable association of the winch frame and the 7 slack adjuster are shown, without limitation.

The load binding device disclosed herein is made from material readily known and available. Shaft material may be comprised of, without limitation, 4140 alloy steel, cold rolled steel, and/or form casting center slot or slots (such as a form casting 9 width center slot) for strap insertion. In general, the load binding device dislosed herein may be comprised of material, without limitation, selected from the group consisting of carbon steel, aluminum, stainless steel, carbon composite, and a combination thereof.

The load binding device disclosed herein may incorporate any number of design features, dimensions, and/or variations known and/or readily available to the skilled artisan. For example, the load binding device of the present invention may include, without limitation, any component and/or components, part and/or parts common to and/or related to and/or used in association with a load binding winch and/or a slack adjuster.

The load binding device disclosed herein may additionally be offered, without limitation, in a kit comprising the device, load tie-downs, and/or a corresponding hand tool for setting the locking mechanism.

Without departing from the scope and spirit of the present invention, reasonable features, dimensions, modifications, advantages, and design variations of the claimed load binding device will become readily apparent to those skilled in the art by following the guidelines set forth in the preceding detailed description and embodiments.

1. A load binding device for tightening and securing loads on a deck or flatbed surface; the device comprising a winch in operable association with a slack adjuster; wherein the slack adjuster comprises a locking mechanism.

2. The load binding device of claim 1, wherein the locking mechanism is a semi-automatic locking mechanism.

3. The load binding device of claim 1, wherein the locking mechanism comprises a bolt head.

4. The load binding device of claim 3, wherein the bolt head is a 9/16″ bolt head.

5. The load binding device of claim 3, wherein the bolt head operably corresponds to a hand tool.

6. The load binding device of claim 5, wherein the hand tool is a wrench or hand ratchet.

7. The load binding device of claim 6, wherein the wrench is an electric or pneumatic impact wrench and the ratchet is a hand ratchet or a speed handle.

8. The load binding device of claim 1, wherein the load binding device is capable of being mounted to the deck or flatbed surface.

9. A load binding winch system for tightening and securing loads on a deck or flatbed surface; wherein the system comprises:
a. at least one load binding device comprising a winch in operable association with a slack adjuster, wherein the slack adjuster comprises a locking mechanism;
b. at least one tie down for tightening a load to the deck or flatbed surface; and
c. a hand tool for setting or releasing the locking mechanism of the device, wherein each individual load binding device is used with a single tie down.
